(19) United States
(12) Patent Application Publication
(10) Pub. No.: US 2015/0221303 A1
(43) Pub. Date: Aug. 6, 2015

(54) DISCUSSION LEARNING SYSTEM AND METHOD USING THE SAME

(71) Applicant: ELECTRONICS AND TELECOMMUNICATIONS RESEARCH INSTITUTE, Daejeon (KR)

(72) Inventors: Jeom Ja KANG, Daejeon (KR); Hyung Bae JEON, Daejeon (KR); Yun Keun LEE, Daejeon (KR); Ho Young JUNG, Daejeon (KR)

(73) Assignee: ELECTRONICS AND TELECOMMUNICATIONS RESEARCH INSTITUTE, Daejeon (KR)

(21) Appl. No.: 14/595,238

(22) Filed: Jan. 13, 2015

(30) Foreign Application Priority Data
Feb. 4, 2014 (KR) 10-2014-0012415

(51) Int. Cl. G10L 15/08; G09B 5/00; G10L 17/22

(52) U.S. Cl. CPC G10L 15/08; G10L 17/22; G09B 5/00

(57) ABSTRACT

Provided are a discussion learning system enabling a discussion learning to proceed based on a speech recognition system without an instructor and a method using the same, the discussion learning system including an learning content providing server configured to provide a discussion environment, extract speeches of learners joining a discussion, and generate speech information based on the extracted speeches, and a speech recognition server configured to perform a speech recognition with respect to each of the learners based on the speech information, determine a progress of the discussion based on a result of the speech recognition, and provide the learning content providing server with interpretation information for smoothly continuing the discussion.

### CROSS-REFERENCE TO RELATED APPLICATION

This application claims priority to and the benefit of Korean Patent Application No. 10-2014-0012415, filed on Feb. 4, 2014, the disclosure of which is incorporated herein by reference in its entirety.

### BACKGROUND

1. Field of the Invention

The present invention relates to a discussion learning system and a method using the same, and more particularly, to a discussion learning system enabling a discussion learning to proceed based on a speech recognition system without an instructor and a method using the same.

2. Discussion of Related Art

A conventional speech recognition system-based English learning system delivers instruction by connecting a learner to a cyber English instructor.

The learner receives instruction according to a program provided from an online English learning system, which evaluates the learner's pronunciation or provides the learner with a reference sentence matching the level of the learner such that the learner repeatedly practices speaking to improve his or her speaking skill.

However, such a learning method is more suitable for a learner who has just started learning English, and for a learner who has surpassed a predetermined level to practice speaking English more freely as desired, a person-to-person communication is the most effective method instead of the cyber English teacher providing a limited instruction.

Accordingly, a discussion-based English speaking learning has been introduced as a method of improving a speaking skill of a learner who reaches a predetermined level or above.

The discussion-based English speaking learning allows a plurality of learners and an instructor to join therein and discuss a suggested subject.

In this case, the instructor serves to enable the discussion to smoothly continue by adjusting the direction of a discussion during the discussion, and inducing the learners to more actively join the discussion and motivate the learners to speak more.

However, such a discussion-based English speaking learning requires a native speaker teacher or an English teacher to conduct the education, so there is an inconveniency of employing a teacher or a coordinator who is responsible for the discussion proceeding.

### SUMMARY OF THE INVENTION

The present invention is directed to a discussion learning system enabling a discussion learning to proceed based on a speech recognition system without an instructor, and a method using the same.

According to an aspect of the present invention, there is provided a discussion learning system including: an learning content providing server configured to provide a discussion environment, extract speeches of learners joining a discussion, and generate speech information based on the extracted speeches; and a speech recognition server configured to perform a speech recognition with respect to each of the learners based on the speech information, determine a progress of the discussion based on a result of the speech recognition, and provide the learning content providing server with interpretation information for smoothly continuing the discussion.

The learning content providing server may include: a plurality of speech extracting units to extract respective speeches of learners joining a discussion; and a discussion management unit configured to generate the speech information by receiving and integrating the speeches extracted by the plurality of speech extracting units.

The learning content providing server may receive the interpretation information from the speech recognition server, and provide all or a part of the learners joining the discussion with content included in the interpretation information.

The speech recognition server may determine the progress of the discussion by analyzing whether details of the discussion are appropriate for the discussion, the discussion is substantial, and a smooth communication is achieved between learners, based on the result of the speech recognition.

The speech recognition server may include: a speech recognition management unit configured to receive the speech information provided from the learning content providing server; a speech recognition unit configured to perform a speech recognition on the speech information received by the speech recognition management unit; and an analysis unit configured to generate the interpretation information by analyzing a result of the speech recognition obtained from the speech recognition unit and determining a progress of the discussion.

The speech recognition management unit may receive the interpretation information from the analysis unit, and may provide the learning content providing server with the received interpretation information.

The analysis unit may include: a first analysis unit configured to determine whether details of a discussion are appropriate for the discussion by analyzing relevancy between a discussion subject word that is prepared in advance and a keyword obtained from the result of the speech recognition; a second analysis unit configured to determine whether a discussion is substantial by analyzing whether Korean language is used, whether a slang is used, and how fast an utterance occurs, based on the result of the speech recognition; and a third analysis unit configured to determine whether a smooth discussion is achieved by analyzing whether vocalizations equally occur among learners joining a discussion based on the result of the speech.

The first analysis unit, if it is determined that the details of the discussions are inappropriate for the discussion, may generate interpretation information including content indicating that the details of the discussion are inappropriate.

The second analysis unit, if it is determined that Korean language is used, may generate interpretation information including content recommending use of a designated language.

The second analysis unit, if it is determined that a slang is used, may generate interpretation information including content allowing a standard language corresponding to the slang to be informed together with content recommending refraining use of the slang.

The second analysis unit, if it is determined that a speed of the utterance is slower than a reference speed, may generate interpretation information allowing an image or a sentence configured to attract an attention of the learners to be provided.

The third analysis unit, if it is determined that a speech of a certain learner is continuously input and that of another learner is intermittently input, may generate interpretation information allowing the other learner intermittently joining the discussion to have an opportunity to speak.

According to another aspect of the present invention, there is a provided a discussion learning method including: by a learning content providing server, providing learners with a discussion environment; by the learning content providing server, extracting speeches of learners joining a discussion and generating speech information; by a speech recognition server having received the speech information, performing a speech recognition on each of the speeches included in the speech information that are divided according to the learners; and by the speech recognition server, determining a progress of the discussion by analyzing a result of the speech recognition, and providing the learning content providing server with interpretation information for smoothly continuing the discussion.

The providing of the discussion environment may be achieved by allowing a learner to select a discussion room provided by the learning content providing server and other learners who are to join the discussion with the learner after connecting to the learning content providing server.

In the providing of the interpretation information, it may be determined whether details of the discussion are appropriate for the discussion by analyzing relevancy between a discussion subject word that is prepared in advance and a keyword obtained from the result of the speech recognition, and if it is determined that the details of the discussions are inappropriate for the discussion, interpretation information including content indicating that the details of the discussion are inappropriate may be provided.

In the providing of the interpretation information, if it is determined that Korean language is used, interpretation information including content recommending use of a designated language may be provided, and if it is determined that a slang is used, interpretation information including content allowing a standard language corresponding to the slang to be informed together with content recommending refraining use of the slang may be provided, and if it is determined that a speed of the utterance is slower than a reference speed, interpretation information allowing an image or a sentence configured to attract an attention of the learners to be provided may be provided.

In the providing of the interpretation information, if it is determined that a speech of a certain learner is continuously input and a speech of another learner is intermittently input, interpretation information allowing the other learner intermittently joining the discussion to have an opportunity to speak may be provided.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a view illustrating a configuration of a discussion learning system according to an exemplary embodiment of the present invention;

FIG. 2 is a view illustrating a configuration of a learning content providing server of a discussion learning system according to an exemplary embodiment of the present invention;

FIG. 3 is a view illustrating a configuration of a speech recognition server of a discussion learning system according to an exemplary embodiment of the present invention; and

FIG. 4 is a flowchart showing a learning method using a discussion learning system according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention. In reference drawings for describing exemplary embodiments of the present invention, size, height, thickness, etc. may be intentionally exaggerated for convenience of description and ease of understanding. Also, the terms described below are defined in consideration of the functions in the present invention, and thus may vary depending on a user, intention of an operator, or custom. Accordingly, the definition would be made on the basis of the whole specification.

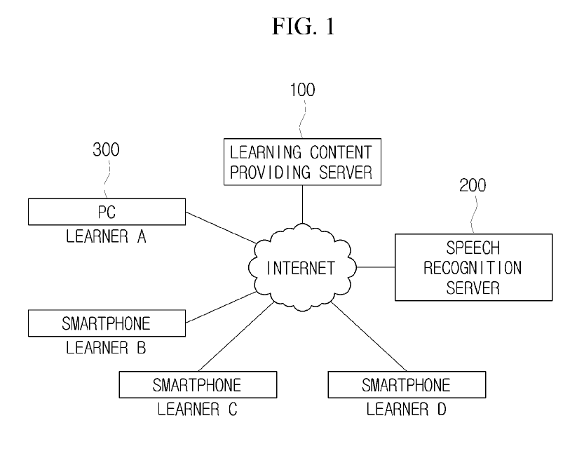

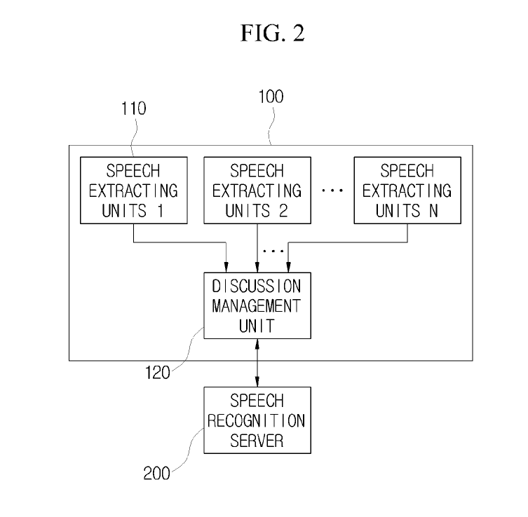

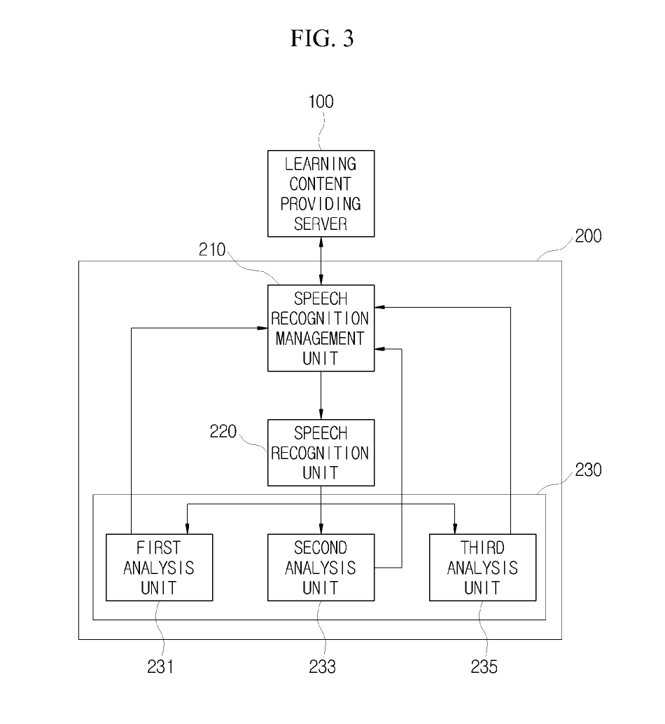

FIG. 1 is a view illustrating a configuration of a discussion learning system according to an exemplary embodiment of the present invention, FIG. 2 is a view illustrating a configuration of a content providing server of a discussion learning system according to an exemplary embodiment of the present invention, and FIG. 3 is a view illustrating a configuration of a speech recognition server of a discussion learning system according to an exemplary embodiment of the present invention.

Referring to FIG. 1, a discussion learning system according to an exemplary embodiment of the present invention includes a learning content providing server 100, a speech recognition server 200, and a plurality of user devices 300.

The discussion learning system according to an exemplary embodiment of the present invention may be applied to an English speaking learning system, and also applied to a system for learning to speak other languages than English in the same manner.

The learning content providing server 100, the speech recognition server 200, and the plurality of user devices 300 may be connected to each other through a network, and the network may be the Internet.

The user device 300 may be an interface for providing an environment in which a learner, desiring to receive education by using a discussion learning system suggested by the present invention learns together and receives education with other learners. For example, the user device 30 may be a smartphone or a PC.

That is, a learner may receive education through a discussion with other learners after connecting to the learning content providing server 100 by use of the user device 300. Accordingly, it should be understood that a learner described hereinafter represents the user device 300.

The learning content providing server 100 provides the user device 300 with a function to provide the user device 300 with learning content, a function to care learners, a function to provide a class for each learner to separately receive education, a function to handle attendance and evaluation of learners, and a function to provide a discussion room.

A learner may join a discussion by connecting to the learning content providing server 100 and selecting a discussion room provided by the learning content providing server 100. In this case, the learning content providing server 100 may not only provide each discussion room but also provide a subject to be discussed in the discussion room.

That is, since a subject to be discussed in each discussion room is determined in advance, the learner is able to select a discussion room by checking a discussion subject.

In addition, the learning content providing server 100 may display learners who join each discussion room as well as displaying the levels of the corresponding learners.

Accordingly, a learner joining a discussion room may check levels of other learners joining the discussion room, and select learners who are determined to have levels suitable for having a discussion with the learner. In this case, the number of learners to be selected may be various, and speeches of learners are converted into a predetermined data format and provided to the speech recognition server 200.

In addition, the learning content providing server 100 provides all or a part of learners joining a discussion with interpretation information provided from the speech recognition server 200. If the interpretation information provided from the speech recognition server 200 is information related to irrelevancy with a direction of a current discussion, or information regarding to continue a smooth discussion, such as information indicating low participating rates of learners joining the discussion, the learning content providing server 100 may provide all the learners with interpretation information.

If the interpretation information provided by the speech recognition server 200 is information related to a certain learner, for example, information allowing only some of learners to join a discussion among all the learners, the learning content providing server 100 may provide only the corresponding learners with the interpretation information.

The learning content providing server 100 may include a plurality of speech extracting units 110 to extract respective speeches of learners who join a discussion, and a discussion management unit 120 configured to generate speech information by receiving and integrating the speeches extracted by the plurality of speech extracting units 110.

In addition, the discussion management unit 120 receives and analyzes the interpretation information provided by the speech recognition server 200, and provides learners with a result of the analysis such that a smooth discussion is achieved.

The speech recognition server 200 receives the speech information from the learning content providing server 100, and performs speech recognition on the speech information.

In addition, the speech recognition server 200 determines a progress of the discussion based on a result of the speech recognition. In this case, the speech recognition server 200 determines a progress of the discussion by analyzing whether details of the discussion are appropriate for the discussion, the discussion is substantial, and a smooth communication is achieved between learners, and provides the learning content providing server 100 with interpretation information appropriate for the status of the discussion.

The speech recognition server 200 may include a speech recognition management unit 210 configured to receive the speech information provided by the learning content providing server 100, a speech recognition unit 220 configured to perform a speech recognition on the speech information, and an analysis unit 230 configured to generate the interpretation information by analyzing a result of the speech recognition and determining a progress of a discussion.

The speech recognition management unit 210 receives the interpretation information provided from the analysis unit 230, and provides the interpretation information to the learning content providing server 100.

Meanwhile, the speech recognition unit 220 performs speech recognition on each of speeches of a plurality of learners included in the speech information that are divided according to the learners.

The analysis unit 230 may include a first analysis unit 231 configured to determine whether details of a discussion are appropriate for the discussion by analyzing a relevancy between a discussion subject word that is prepared in advance and a keyword obtained from the result of the speech recognition in the speech recognition unit 220, a second analysis unit 233 configured to determine whether a discussion is substantial by analyzing whether Korean language is used, whether a slang is used, and how fast utterance occurs, based on the result of the speech recognition in the speech recognition unit 220, and a third analysis unit 235 configured to determine whether a smooth discussion is achieved by analyzing whether vocalizations equally occur among learners joining a discussion based on the result of the speech recognition in the speech recognition unit 220.

In this case, the first analysis unit 231 waits for the next result of speech recognition to be received if it is determined that details of the discussion are appropriate for the discussion, and provides the speech recognition management unit 210 with details about being inappropriate if it is determined that details of the discussion are inappropriate for the discussion.

Meanwhile, the second analysis unit 233, if it is determined as a result of the speech recognition in the speech recognition unit 220 that Korean language is used, provides the speech recognition management unit 210 with content recommending use of English.

In addition, the second analysis unit 233, if it is determined as a result of the speech recognition in the speech recognition unit 220 that a slang is used, provides information about a standard language corresponding to the slang together with content instructing the learners to refrain from using the slang.

In addition, the second analysis unit 233, if it is determined that a speed of the utterance is slower than a reference speed, provides the speech recognition management unit 210 with information related to an image or a sentence configured to attract an attention of the learners.

Meanwhile, the third analysis unit 235 determines that a discussion smoothly continues if the numbers of vocalizations among respective learners are similar.

In addition, the third analysis unit 235 determines that a discussion does not smoothly continue if a speech of a certain learner is continuously input and that of another learner is intermittently input, and provides the speech recognition management unit 210 with information allowing the other learner to have an opportunity to speak.

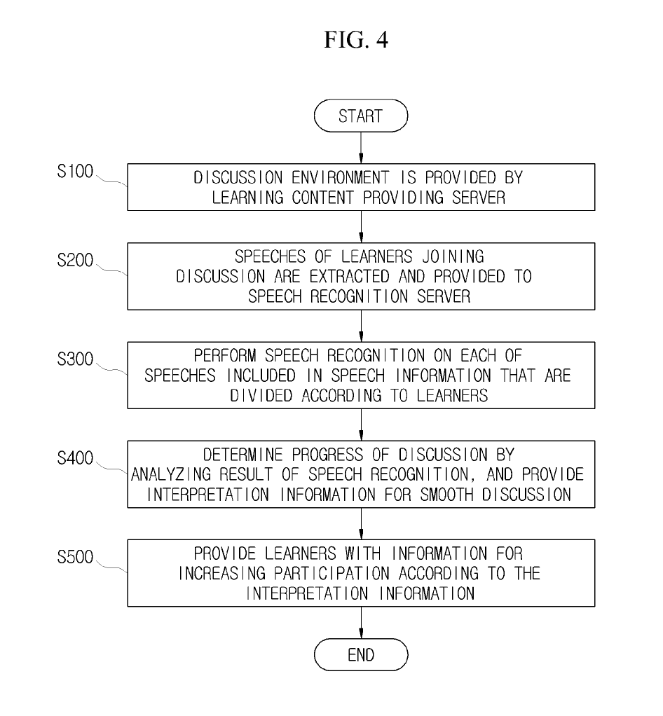

FIG. 4 is a flowchart showing a learning method using the discussion learning system according to an exemplary embodiment of the present invention.

Referring to FIG. 4, first, the learning content providing server 100 provides a learner with a discussion environment (S100).

The providing of the discussion environment is achieved by allowing a learner to connect to the learning content providing server 100 and select a discussion room provided by the learning content providing server 100 and learners to have a discussion together.

In this case, the learning content providing server 100 may provide a subject to be discussed in a discussion room as well as providing each discussion room. Accordingly, the learner is able to select a discussion room by checking a discussion subject.

In addition, the learning content providing server 100 may display learners who join each discussion room as well as displaying the levels of the corresponding learners. Accordingly, a learner joining a discussion room may check levels of other learners joining the discussion room, and select learners who are determined to have levels suitable for having a discussion with the learner.

When a discussion is held in a state that such a discussion environment is provided, the learning content providing server 100 extracts respective speeches of learners joining the discussion, generates speech information, and provides the speech recognition server 200 with the generated speech information (S200).

The speech recognition server 200 having received speech information from the learning content providing server 100 performs speech recognition on each of speeches included in the speech information that are divided according to the learners (S300).

After the speech recognition, the speech recognition server 200 determines a progress of the discussion by analyzing a result of the speech recognition, and provides the learning content providing server 100 with interpretation information for a smooth discussion (S400).

In this case, the speech recognition server 200 determines whether details of a discussion are appropriate for the discussion by analyzing a relevancy between a discussion subject word that is prepared in advance and a keyword obtained from the result of the speech recognition in the speech recognition server 200.

In this case, the speech recognition server 200 determines whether a discussion is substantial by analyzing whether Korean language is used, whether a slang is used, and how fast utterance occurs, and also determines whether a smooth discussion is achieved by analyzing whether vocalizations equally occur among learners joining the discussion, based on the result of the speech recognition in the speech recognition server 200.

Meanwhile, if it is determined that details of a discussion are inappropriate for the discussion, the speech recognition server 200 provides interpretation information indicating that the details are beyond the subject of the discussion.

In addition, if it is determined that Korean language is used, the speech recognition server 200 provides interpretation information recommending using English.

In addition, if it is determined that a slang is used, the speech recognition server 200 provides interpretation information recommending refraining using the slang and allowing a standard language corresponding to the slang to be informed.

In addition, if it is determined that a speed of the utterance is slower than a reference speed, the speech recognition server 200 provides interpretation information allowing an image or a sentence configured to attract an attention of the learners to be provided.

Meanwhile, if a speech of a certain learner is continuously input and a speech of another learner is intermittently input, the speech recognition server 200 determines that a discussion does not smoothly continue, and provides information allowing the other learner to have an opportunity to speak.

As such, the learning content providing server 100 having received the plurality of pieces of interpretation information with regard to appropriacy of the details of the discussion provides learners with information for increasing participation according to the interpretation information for a smooth discussion progress provided by the speech recognition server 200 (S500).

According to the embodiments of the present invention, tt can be determined whether the discussion is smoothly conducted, based on a speech recognition with respect to learners joining a discussion.

In addition, information for a smooth discussion can be provided to the learners depending on the result of the determination.

Since the discussion learning is achieved based on a speech recognition system, the efficiency in the discussion-based learning of speaking is maximized.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A discussion learning system comprising:
an learning content providing server configured to provide a discussion environment, extract speeches of learners joining a discussion, and generate speech information based on the extracted speeches; and
a speech recognition server configured to perform a speech recognition with respect to each of the learners based on the speech information, determine a progress of the discussion based on a result of the speech recognition, and provide the learning content providing server with interpretation information for smoothly continuing the discussion.

2. The discussion learning system of claim 1, wherein the learning content providing server includes:
a plurality of speech extracting units to extract respective speeches of learners joining a discussion; and
a discussion management unit configured to generate the speech information by receiving and integrating the speeches extracted by the plurality of speech extracting units.

3. The discussion learning system of claim 1, wherein the learning content providing server receives the interpretation information from the speech recognition server, and provides all or a part of the learners joining the discussion with content included in the interpretation information.

4. The discussion learning system of claim 1, wherein the speech recognition server determines the progress of the discussion by analyzing whether details of the discussion are appropriate for the discussion, the discussion is substantial, and a smooth communication is achieved between learners, based on the result of the speech recognition.

5. The discussion learning system of claim 1, wherein the speech recognition server comprises:
a speech recognition management unit configured to receive the speech information provided from the learning content providing server;
a speech recognition unit configured to perform a speech recognition on the speech information received by the speech recognition management unit; and
an analysis unit configured to generate the interpretation information by analyzing a result of the speech recognition obtained from the speech recognition unit and determining a progress of the discussion.

6. The discussion learning system of claim 5, wherein the speech recognition management unit receives the interpretation information from the analysis unit, and provides the learning content providing server with the received interpretation information.

7. The discussion learning system of claim 5, wherein the analysis unit comprises:
a first analysis unit configured to determine whether details of a discussion are appropriate for the discussion by analyzing relevancy between a discussion subject word that is prepared in advance and a keyword obtained from the result of the speech recognition;
a second analysis unit configured to determine whether a discussion is substantial by analyzing whether Korean language is used, whether a slang is used, and how fast an utterance occurs, based on the result of the speech recognition; and
a third analysis unit configured to determine whether a smooth discussion is achieved by analyzing whether vocalizations equally occur among learners joining a discussion based on the result of the speech recognition.

8. The discussion learning system of claim 7, wherein the first analysis unit, if it is determined that the details of the discussions are inappropriate for the discussion, generates interpretation information including content indicating that the details of the discussion are inappropriate.

9. The discussion learning system of claim 7, wherein the second analysis unit, if it is determined that Korean language is used, generates interpretation information including content recommending use of a designated language.

10. The discussion learning system of claim 7, wherein the second analysis unit, if it is determined that a slang is used, generates interpretation information including content allowing a standard language corresponding to the slang to be informed together with content recommending refraining use of the slang.

11. The discussion learning system of claim 7, wherein the second analysis unit, if it is determined that a speed of the utterance is slower than a reference speed, generates interpretation information allowing an image or a sentence configured to attract an attention of the learners to be provided.

12. The discussion learning system of claim 7, wherein the third analysis unit, if it is determined that a speech of a certain learner is continuously input and a speech of another learner is intermittently input, generates interpretation information allowing the other learner intermittently joining the discussion to have an opportunity to speak.

13. A discussion learning method comprising:
by a learning content providing server, providing learners with a discussion environment;
by the learning content providing server, extracting speeches of learners joining a discussion and generating speech information;
by a speech recognition server having received the speech information, performing a speech recognition on each of the speeches included in the speech information that are divided according to the learners; and
by the speech recognition server, determining a progress of the discussion by analyzing a result of the speech recognition, and providing the learning content providing server with interpretation information for smoothly continuing the discussion.

14. The discussion learning method of claim 13, wherein the providing of the discussion environment is achieved by allowing a learner to select a discussion room provided by the learning content providing server and other learners who are to join the discussion with the learner after connecting to the learning content providing server.

15. The discussion learning method of claim 13, wherein in the providing of the interpretation information, it is determined whether details of the discussion are appropriate for the discussion by analyzing relevancy between a discussion subject word that is prepared in advance and a keyword obtained from the result of the speech recognition, and if it is determined that the details of the discussions are inappropriate for the discussion, interpretation information including content indicating that the details of the discussion are inappropriate is provided.

16. The discussion learning method of claim 13, wherein in the providing of the interpretation information, if it is determined that Korean language is used, interpretation information including content recommending use of a designated language is provided, and if it is determined that a slang is used, interpretation information including content allowing a standard language corresponding to the slang to be informed together with content recommending refraining use of the slang is provided, and if it is determined that a speed of the utterance is slower than a reference speed, interpretation information allowing an image or a sentence configured to attract an attention of the learners to be provided is provided.

17. The discussion learning method of claim 13, wherein in the providing of the interpretation information, if it is determined that a speech of a certain learner is continuously input and a speech of another learner is intermittently input, interpretation information allowing the other learner intermittently joining the discussion to have an opportunity to speak is provided.
